(19) United States
(12) Patent Application Publication
(10) Pub. No.: US 2026/0254484 A1
(43) Pub. Date: Aug. 27, 2026

(54) USING RECONFIGURABLE INTELLIGENT SURFACES TO ENHANCE SELF-INTERFERENCE CANCELLATION IN A FULL DUPLEX SYSTEM

(71) Applicant: HUAWEI TECHNOLOGIES CO., LTD., SHENZHEN (CN)

(72) Inventors: James Gary GRIFFITHS, Kanata (CA); Jamal Mohamed Ahmouda ZAID, Kanata (CA); Jianpeng ZHANG, Kanata (CA); Philippe WU, Kanata (CA); Philippe GUILLEMETTE, Kanata (CA); Peiwei WANG, Kanata (CA)

(73) Assignee: HUAWEI TECHNOLOGIES CO., LTD., SHENZHEN (CN)

(21) Appl. No.: 19/064,099

(22) Filed: Feb. 26, 2025

(51) Int. Cl. H04B 7/04; H04L 5/14; H04W 24/02; H04W 52/36

(52) U.S. Cl. CPC H04B 7/04013; H04L 5/14; H04W 24/02; H04W 52/367

(57) ABSTRACT

Methods, apparatus, and systems for over-the-air cancellation of interfering wireless signals are provided. In embodiments, a reconfigurable surface is placed in the vicinity of an antenna and tuned to decrease the power of interfering wireless signals being received by the antenna. The reconfigurable surface comprises cell elements each having a respective reflection coefficient that can be adjusted to reflect and phase shift a portion of the interfering wireless signals to cause destructive interference with another portion at the antenna. In some embodiments, the adjustments are optimized through an iterative algorithm such as an artificial intelligence algorithm. Embodiments can facilitate improved reception of desired signals and minimized reception of in-band or out-of-band interference to enable full-duplex wireless communication between stations of a network.

### CROSS-REFERENCE TO RELATED APPLICATIONS

This is the first application filed for the present invention.

### FIELD OF THE INVENTION

The present application pertains to communications networks and in particular to methods, apparatus, and systems for full-duplex communication.

### BACKGROUND

In full-duplex wireless communication, data is simultaneously transmitted and received by stations communicating with each other on a same frequency band. Each station uses a pair of channels for transmitting data to and receiving data from another station. In contrast with half-duplex communication, where only one station can transmit data at a given time, full-duplex communication can enable information to be transferred twice as fast. However, in full-duplex wireless communication, energy associated with a signal transmitted from a station through one channel can interfere with the energy associated with a signal received by the station through the other, adjacent channel. Thus, in full-duplex communication, the interference at the station receiver can include out-of-band interference, such as from spectral regrowth, as well as in-band interference. Interference can cause the station to become desensitized to the received signals and therefore unable to detect low-level signals.

To minimize desensitization, approaches have been developed to isolate the interfering energy from received signals. This has typically involved increasing the physical separation between the transmitter and receiver antennae of a station or installing barriers, such as absorbers or chokes, between the antennae. However, these approaches are often impractical and lead to cumbersome station designs, and they further do not address out-of-band interference. Alternative approaches have focused on cancelling out the interference. In some methods, the transmitted signal may be sampled with taps prior to transmission and manipulated electronically before being added to cancel leakage at a receiver. These approaches typically require many taps for good cancellation, require high-linearity components or additional nonlinear cancellation, and only address interference generated by the operator's system of stations. Some other methods use over-the-air sampling and electronic cancellation, wherein a directional sampling antenna may be used to tap interfering signals. An electronic phase shifter, electronic attenuator, delay control, and coupler may be used to manipulate the tapped signal and add it electronically to signals received by a station receiver. These approaches are typically complex and require numerous additional components. In some further approaches, null steering may be used to improve the directionality of a transmitted signal while suppressing leakage of the signal towards unintended recipients. However, these approaches add complexity, introduce insertion loss, and are only effective in far-field situations, with fully formed transmission beams. Typically, the receiving antenna of a station is within the near-field of the station's transmitting antenna. Thus, currently available approaches for mitigating interference in full-duplex radio communication typically suffer from being overly complex and requiring extensive component additions or from being limited to in-band or far-field interference.

Therefore, there is a need for a methods, systems and apparatus for full-duplex wireless communication that obviates or mitigates one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

An object of embodiments of the present disclosure is to provide a methods, systems, and apparatus for cancelling interference, especially for full-duplex communication.

A first aspect of the present disclosure is to provide a communication system comprising a receiver, a reconfigurable surface (RS), and a controller. The receiver may include an antenna configured to receive one or more wireless signals each having associated thereto a respective power. The receiver may be configured to produce, in response to receiving the one or more wireless signals, an electrical signal having associated thereto a performance metric having a performance metric value that depends from the respective power of each of the one or more wireless signals. The RS may include a plurality of cell elements each having at least one respective parameter configured to be adjusted to modify a respective reflection coefficient of the respective cell element. The controller may be coupled to the receiver and to the plurality of cell elements of the RS. The controller may be configured to obtain the performance metric value and to optimize the performance metric value by adjusting the at least one respective parameter of each cell element of a set of cell elements among the plurality of cell elements of the RS to decrease, at the antenna of the receiver, the respective power of at least one wireless signal among the one or more wireless signals.

In some examples or implementations of the first aspect, the controller may be configured to optimize the performance metric value by adjusting the at least one respective parameter of each cell element of the set of cell elements of the RS to reflect a first portion of the at least one wireless signal towards the antenna of the receiver to cause the first portion of the at least one wireless signal to destructively interfere with a second portion of the at least one wireless signal at the antenna of the receiver. In some of these examples or implementations, the controller may be configured to adjust the at least one respective parameter of each cell element of the set of cell elements of the RS to phase shift the first portion of the at least one wireless signal.

In some examples or implementations of the first aspect, the one or more wireless signals may include a first wireless signal transmitted from a first transmitter antenna and a second wireless signal transmitted from a second transmitter antenna. Decreasing, at the antenna of the receiver, the respective power of the at least one wireless signal may include decreasing, at the antenna of the receiver, the respective power of the first wireless signal or the second wireless signal.

In some examples or implementations of the first aspect, the one or more wireless signals may include a first wireless signal transmitted from a first transmitter antenna and a second wireless signal transmitted from a second transmitter antenna wherein the first transmitter antenna is remote to the communication system and the communication system further comprises the second transmitter antenna. Decreasing, at the antenna of the receiver, the respective power of the at least one wireless signal among the one or more wireless signals may include decreasing, at the antenna of the receiver, only the respective power of the second wireless signal among the one or more wireless signals. In some of these examples or implementations, the RS may be positioned between the second transmitter antenna and the antenna of the receiver and the RS may be oriented to cause a portion of the second wireless signal transmitted from the second transmitter antenna to be reflected towards the antenna of the receiver.

In some examples or implementations of the first aspect, the controller may be further configured to optimize the performance metric value by adjusting the at least one respective parameter of each cell element of a further set of cell elements among of the plurality of cell elements of the RS to decrease, at the antenna of the receiver, the respective power of a further at least one wireless signal among the one or more wireless signals. In some of these examples or implementations, at least one cell element of the set of cell elements of the RS and at least one cell element of the further set of cell elements of the RS may be a respective same cell element among the plurality of cell elements of the RS.

In some examples or implementations of the first aspect, the RS may have, relative to the antenna of the receiver, a position and an orientation configured to further optimize the performance metric value by further decreasing, at the antenna of the receiver, the respective power of the at least one wireless signal among the one or more wireless signals.

In some examples or implementations of the first aspect, the controller may be configured to optimize the performance metric value by implementing an iterative optimization algorithm. In some of these examples or implementations, the iterative optimization algorithm may be an artificial intelligence algorithm. In some examples or implementations, the artificial intelligence algorithm may be a particle swarm optimization algorithm.

In some examples or implementations of the first aspect, at least one respective parameter of each cell element of the plurality of cell elements may include a respective voltage, and the controller may include one or more digital-to-analog converters (DACs) configured to adjust, for each cell element of a respective group of cell elements among the plurality of cell elements of the RS, the respective voltage. The controller may be configured to optimize the performance metric value by controlling the DACs to adjust, for each cell element of the respective group of cell elements among the plurality of cell elements of the RS, the respective voltage. In some example or implementations, the respective reflection coefficient of each cell element includes a respective phase component and the at least one respective parameter of each cell element being configured to be adjusted to modify the respective reflection coefficient may include the respective voltage of each cell element being configured to be adjusted to modify the respective phase component.

In some examples or implementations of the first aspect, the at least one respective parameter of each cell element of the plurality of cell elements may include a respective current, and the controller may be configured to optimize the performance metric value by adjusting the respective current of each cell element of the set of cell elements of the RS.

In some examples or implementations of the first aspect, the performance metric value may depend from a sum of the respective power of each wireless signal of the one or more wireless signals, and the controller may be configured to minimize the sum of the respective power of each wireless signal of the one or more wireless signals by adjusting the at least one respective parameter of the each cell element of the set of cell elements among the plurality of cell elements of the RS to decrease, at the antenna of the receiver, the respective power of the at least one wireless signal among the one or more wireless signals.

A second aspect of the present disclosure is to provide a full-duplex communication system. The system may comprise a first station and a second station. The first station may include a first receiver antenna, a first transmitter antenna, a RS, and a controller. The RS may include a plurality of cell elements each having at least one respective parameter configured to be adjusted to modify a respective reflection coefficient of the respective cell element. The controller may be coupled to the first receiver antenna and to the plurality of cell elements of the RS. The second station may include a second receiver antenna and a second transmitter antenna. The first transmitter antenna may be configured to transmit wireless signals towards the second receiver antenna. The second transmitter antenna may be configured to transmit wireless signals towards the first receiver antenna. Each wireless signal may have associated thereto a respective power. The controller may be configured to adjust the at least one respective parameter of each cell element of a set of cell elements among the plurality of cell elements of the RS to decrease, at the first receiver antenna, the respective power of wireless signals transmitted from the first transmitter antenna.

In some examples or implementations of the second aspect, the second station may further include a further RS and a further controller. The further RS may include a further plurality of cell elements, each cell element of the further plurality of cell elements of the further RS having at least one respective parameter configured to be adjusted to modify a respective reflection coefficient of the respective cell element. The further controller may be coupled to each of the second receiver antenna and the further RS, and may be configured to adjust the at least one respective parameter of each cell element of a further set of cell elements among the plurality of cell elements of the further RS to decrease, at the second receiver antenna, the respective power of wireless signals transmitted from the second transmitter antenna.

A third aspect of the present disclosure is to provide a method to be performed at a receiver station. The method may comprise: producing, in response to receiving one or more wireless signals by an antenna, an electrical signal, with each wireless signal having associated thereto a respective power and the electrical signal having associated thereto a performance metric having a performance metric value that depends from the respective power of each of the one or more wireless signals; obtaining, by a controller coupled to the antenna, the electrical signal, with the controller further being coupled to a RS including a plurality of cell elements each having at least one respective parameter configured to be adjusted to modify a respective reflection coefficient of the respective cell element; and adjusting, by the controller, at least one respective parameter of each cell element of a set of cell elements among the plurality of cell elements of the RS to cause the RS to decrease, at the antenna, the respective power of at least one wireless signal among the one or more wireless signals to optimize the performance metric value.

In some examples or implementations of the third aspect, adjusting, by the controller, the at least one respective parameter of each cell element of the set of cell elements among the plurality of cell elements of the RS to cause the RS to decrease, at the antenna, the respective power of the at least one wireless signal among the one or more wireless signals to optimize the performance metric value may include implementing, by the controller, an artificial intelligence algorithm.

Examples or implementations of embodiments of the present disclosure may facilitate cancellation of in-band and/or out-of-band interference at antennae of a communication system. The cancellation may be achieved over-the-air, in the near-field or far-field, and may not require any electrical cancellation of interfering signals.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1A shows a schematic of an example of cancellation of in-band interference in accordance with an implementation of the present disclosure.

FIG. 1B shows a schematic of an example of cancellation of in-band interference in accordance with another implementation of the present disclosure.

FIG. 2 shows a schematic of an example of cancellation of out-of-band interference in accordance with an implementation of the present disclosure.

FIG. 3 shows a schematic of an example of cancellation of in-band and out-of-band interference in accordance with an implementation of the present disclosure.

FIG. 4A shows a schematic of an example of a reconfigurable surface in accordance with an implementation of the present disclosure.

FIG. 4B shows a schematic of an example of a cell element of a reconfigurable surface in accordance with an implementation of the present disclosure.

FIG. 4C shows a plot of phase shift versus frequency for different voltages applied to a cell element of a reconfigurable surface, in accordance with an implementation of the present disclosure.

FIG. 5 shows a schematic of a receiver and reconfigurable surface for over-the-air cancellation, in accordance with an implementation of the present disclosure.

FIG. 6 shows a flowchart of a method for configuring a reconfigurable surface for over-the-air cancellation in accordance with an implementation of the present disclosure.

FIG. 7 shows a schematic of an apparatus for over-the-air cancellation according to implementation of the present disclosure.

FIG. 8 shows a schematic of an implementation of an electronic device that may implement at least part of the methods and features of the present disclosure.

It will be noted that throughout the appended drawings, like features are identified by like reference numerals.

### DETAILED DESCRIPTION

To facilitate full-duplex wireless communication, embodiments of the present disclosure are generally directed towards cancelling interference in transmissions through use of reconfigurable surfaces (RSs), and in particular through use of reconfigurable intelligent surfaces (RISs). In embodiments, a RS may be placed in the vicinity of an electronic receiver device (or more briefly, a receiver) that includes an antenna configured to receive wireless signals (i.e., a receiver antenna). The RS may include a plurality of cell elements, with each cell element having at least one respective parameter, such as a voltage and/or a current, configured to be adjusted to modify a respective reflection coefficient of the respective cell element. The cell elements of the RS may be arranged as a planar array or a non-planar array. A controller coupled to each of the RS and the receiver may be configured to adjust the at least one respective parameter of at least some cell elements to decrease the power of at least one wireless signal received at the antenna. In particular, the controller may adjust the parameters of those cell elements to decrease the power of wireless signals interfering with reception of a desired or target wireless signal at the antenna. In some embodiments, the respective reflection coefficients of cell elements of the RS may be modified to cause a portion of an interfering wireless signal to be reflected off the RS and to destructively interfere with another portion of that interfering wireless signal that reaches the antenna directly. In other words, the cell elements of the RS may be configured to cause an over-the-air cancellation of the interfering wireless signal. In some embodiments, the parameters of the cell elements may be adjusted to optimize a value of a performance metric that depends from the respective power of each of the wireless signals received by the antenna. The performance metric may be associated with an electrical signal produced by the antenna in response to receiving the wireless signals. The performance metric may, for example, be a received signal strength indicator (RSSI), a signal-to-interference ratio (SIR), or a combination thereof. In some embodiments, optimization of the value of the performance metric may be achieved through an iterative optimization technique or an artificial intelligence technique, such as a particle swarm optimization (PSO) technique. Embodiments of the present disclosure may be implemented to cancel out-of-band interference or in-band interference, such as interference in full-duplex communication. The receiver may be co-located at a communication station with a transmitter including another antenna (i.e., a transmitter antenna) that transmits interfering signals. In some implementations, the parameters of the cell elements may be adjusted to cancel interference from a plurality of transmitter antennae.

Embodiments of the present disclosure may enable a station of a network to locally cancel interfering wireless signals that were generated by the station itself or elsewhere. Use of an RS may provide cancellation of near-field and/or far-field interference as well as in-band and/or out-of-band interference. In contrast with many current systems, embodiments may provide over-the-air cancellation and therefore may not involve cancellation by electronic means. Thus, embodiments may not require wired connection between the receiver antenna and the source of the transmitted interference, as well as additional or highly linear electronic components such as phase shifters, amplitude attenuators, or delay lines. Embodiments may further not require sampling antennae or taps as used in some current systems. By avoiding these requirements, embodiments may provide lower power consumption, less complexity, and greater scalability in comparison to current systems.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to. The terms in each of the following sets may be considered interchangeable throughout the disclosure: cell element and unit cell; target signal and desired signal; reconfigurable surface and reconfigurable intelligent surface; and processing electronics or circuitry and controller.

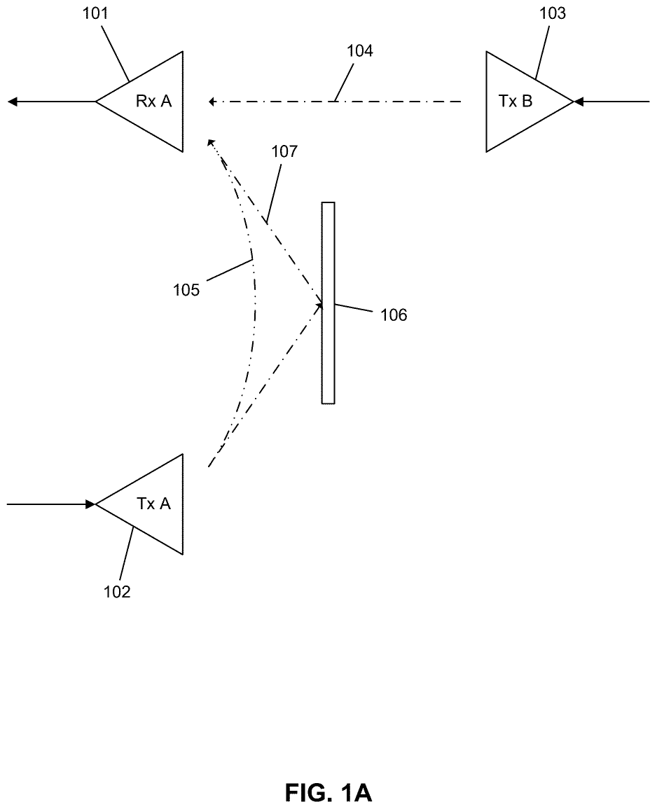

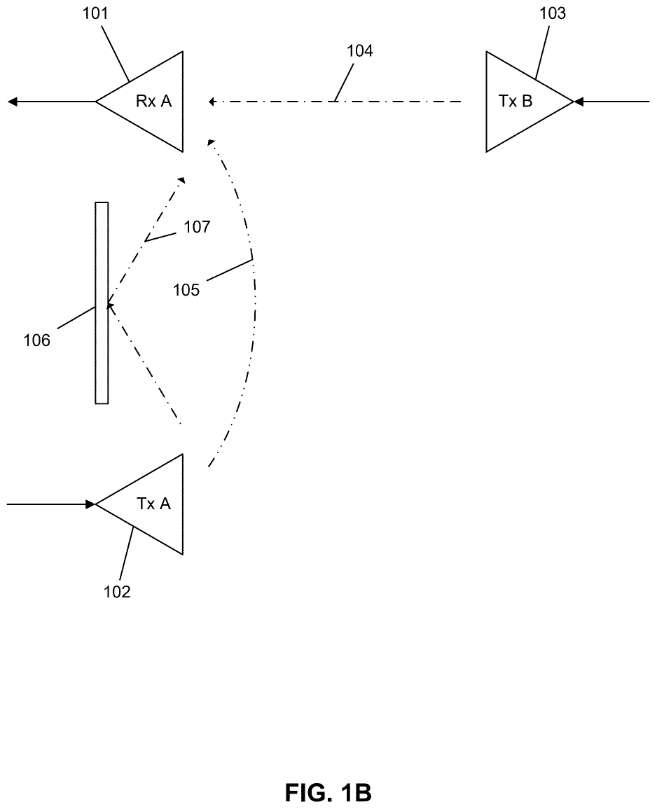

FIG. 1A shows a schematic of an example of cancellation of in-band interference in accordance with an embodiment of the present disclosure. A first receiver (Rx A) 101 and a first transmitter (Tx A) 102 belong to a first station. A first communication channel connects the first receiver 101 to a second transmitter (Tx B) 103 belonging to a second station. The second station may further include a second receiver (not shown) connected to the first transmitter 102 through a second communication channel. The second station may be remote to the first station. Each of the first communication channel 102 and the second communication channel may operate on a same frequency band, which may, for example, be a same wireless radio band. Each of the first station and the second station may be stations belonging to a communications network. In addition, the first station and the second station may be considered as forming a full-duplex communication system. Each of the first receiver 101 and the second receiver may comprise a respective antenna configured to receive wireless signals (i.e., a receiver antenna), such as radio signals, and to produce electrical signals in response to receiving wireless signals. Each of the first receiver 101 and the second receiver may further comprise circuitry or electronic components configured to process electrical signals produced by the respective antenna. Each of the first transmitter 102 and the second transmitter 103 may comprise a respective antenna configured to transmit wireless signals (i.e., a transmitter antenna), such as radio signals. The second transmitter 103 may transmit wireless signals toward the first receiver 101 through the first communication channel. The portion of these wireless signals that are received by the first transmitter 102 may be referred to herein as first wireless signals 104 (depicted by the dash-dash-dot line), or as ‘desired’ or ‘target’ signals. The first wireless signals 104 may have associated thereto a respective power. Wireless signals transmitted from the first transmitter 102, such as towards the second receiver through the second communication channel, may have a portion that leak towards the first receiver 101. The portion of these wireless signals that is received by the first receiver 101 may be referred to herein as second wireless signals 105 (depicted by the dot-dot-dash line), or as ‘interference’ signals. The second wireless signals 105 may interfere with the first wireless signals 104, which may degrade the reception of the first wireless signals 104 by the first receiver 101 and cause desensitization to the first wireless signals 104. The second wireless signals 105 may have associated thereto a respective power.

To cancel the interference from the second wireless signals 105, a RS 106 may be placed in the vicinity of the first receiver 101. The RS 106 may include a plurality of cell elements each having at least one respective parameter, such as a voltage and/or a current, that can be adjusted to modify a respective reflection coefficient r of the respective cell element. The at least one respective parameter of each cell element may, in particular, be adjusted to modify a phase component φ of the respective reflection coefficient, as provided by:

$$r = \vert r \vert {e}^{i φ} \qquad ( 1 )$$

where |r| is the absolute value of the respective reflection coefficient. The RS 106 may be positioned and oriented to intercept a further portion of the wireless signals transmitted by the first transmitter 102. This further portion may be referred to herein as third wireless signals 107 (depicted by the dash-dot line). Some or all of the plurality of cell elements (i.e., a set of cell elements) may have their respective parameters adjusted to decrease, at the first receiver 101, the respective power of the second wireless signals 105. In particular, the respective parameters of the set of cell elements may be adjusted to modify the respective reflection coefficients to cause the third wireless signals 107, which impinge upon the RS 106, to reflect towards the first receiver 101 and to destructively interfere with the second wireless signals 105 (i.e., with a further portion of the wireless signals transmitted from the first transmitter 102). This may include phase shifting the third wireless signals 107.

The respective parameters of the set of cell elements of the RS 106 may be adjusted by a controller (not shown) coupled to each of the RS 106 and the first receiver 101. The controller may, for example, belong to the first station. In response to receiving one or more wireless signals, the first receiver 101 may produce an electrical signal that has associated thereto a performance metric having a value associated (i.e., a performance metric value) that depends from the respective power of each wireless signal received. For example, the performance metric may be a signal-to-interference ratio (SIR) or a received signal strength indicator (RSSI), other quality-of-service (QoS) factor for the desired signal (i.e., the first wireless signals 104), or a combination thereof. The performance metric may depend from a total of the power received by the first receiver 101 from the wireless signals. In the absence of a desired signal, such as may be the case for adjusting or optimizing the RS 106, the performance metric may depend from a sum of the respective power of interference signals (e.g., the second wireless signals 105). The controller may be configured to obtain the electrical signal from first receiver 101 and to optimize the value of the performance metric by adjusting the respective parameters of the set of cell elements of the RS 106. For example, the controller may be configured to adjust the respective parameters of the cell elements to minimize the power received from interference signals or the total power received from all wireless signals (104, 105, 107).

In the example of FIG. 1A the RS 106 is positioned in front of the first receiver 101 and the first transmitter 102, such that the RS 106 is between the first station and the second station. The RS 106 has an orientation to expose it to each of the first receiver 101 and first transmitter 102, such that the RS 106 can intercept and reflect (phase shift) the third wireless signals 107. In this case, the plurality of elements of the RS 106 may face towards each of the first receiver 101 and the first transmitter 102. The first wireless signals 104 transmitted by the second transmitter 103 may be generally unaffected by the RS 106 when it is oriented and positioned in this manner because the RS 106 is oriented to face away from the second transmitter 103. In some other embodiments, the RS 106 may be positioned differently and oriented accordingly.

FIG. 1B shows a schematic of another example for cancellation of in-band interference in accordance with an embodiment of the present disclosure. Similar to the example shown in FIG. 1A, the first receiver 101 and the first transmitter 102 belong to the first station, the first communication channel connects the first receiver 101 to the second transmitter 103 belonging to the second station, and the second station may further include the second receiver (not shown) connected to the first transmitter 102 through the second communication channel. Each of the first communication channel 102 and the second communication channel may similarly operate on the same frequency band. The first receiver 101 may similarly receive the first wireless signals 104 from the second transmitter 103 and receive the second wireless signals 105 from the first transmitter 102, which may interfere with the first wireless signals 104. Unlike the example shown in FIG. 1A, the RS 106 is positioned behind each of the first receiver 101 and the first transmitter 102, such that the RS 106 is further from the second station than each of the first receiver 101 and the first transmitter 102. The RS 106 is then oriented in reverse to face towards the first receiver 101 and the first transmitter 102, such that it can similarly intercept and reflect the third wireless signals 107 towards the first receiver 101. The first wireless signals 104 transmitted by the second transmitter 103 may similarly be unaffected by the RS 106 when it is oriented and positioned in this manner because the RS 106 is positioned behind the first receiver 101 with respect to the second transmitter 103.

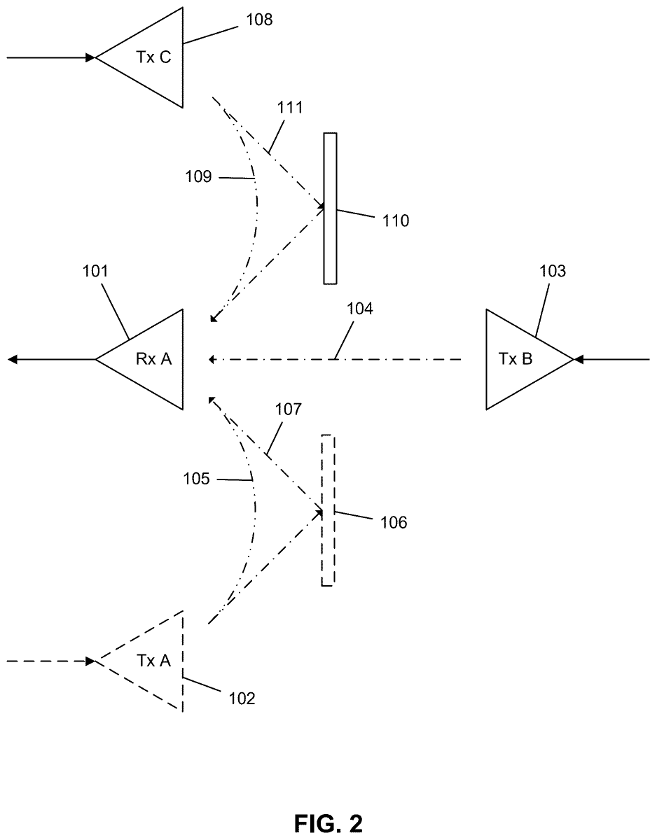

FIG. 2 shows a schematic of an example for cancellation of out-of-band interference in accordance with an embodiment of the present disclosure. Similar to the examples shown in FIGS. 1A and 1B, the first receiver 101 belongs to the first station, and the first communication channel connects the first receiver 101 to the second transmitter 103 belonging to the second station. The first receiver 101 may similarly receive the first wireless signals 104 from the second transmitter 103. Optionally, the first station may include the first transmitter 102, the second station may include the second receiver (not shown) connected to the first transmitter 102 through the second communication channel, and a first RS 106 may be used to cancel in-band interference from the first transmitter 102 at the first receiver 101. Unlike the examples shown in FIGS. 1A and 1B, a third transmitter (Tx C) 108 may be in the vicinity of the first receiver 101. The third transmitter 108 may belong to the first station or a further station that is remote to the first station and/or the second station. The third transmitter 108 may be configured to transmit wireless signals towards a further receiver (not shown) through a further communication channel operating on a frequency band different from that of the first communication channel. A portion of the wireless signals transmitted by the third transmitter 108 may leak towards the first receiver 101. The portion of these wireless signals that is received by the first receiver 101 may be referred to herein as fourth wireless signals 109 (depicted by the dot-dot-dash line), or similarly as ‘interference’ signals. The fourth wireless signals 109 may interfere with the first wireless signals 104, such as by spectral regrowth, which may degrade the reception of the first wireless signals 104 by the first receiver 101 and cause desensitization to the first wireless signals 104. The fourth wireless signals 109 may have associated thereto a respective power.

To cancel the interference from the fourth wireless signals 109, a second RS 110 may be placed in the vicinity of the first receiver 101. The second RS 106 may be configured similarly to the first RS 106, as described in relation to FIG. 1A. The second RS 110 may be positioned and oriented to intercept a further portion of the wireless signals transmitted by the third transmitter 108. This further portion may be referred to herein as fifth wireless signals 111 (depicted by the dash-dot line). At least some of the plurality of cell elements (i.e., a set of cell elements) of the second RS 110 may have their respective parameters adjusted to decrease, at the first receiver 101, the respective power of the fourth wireless signals 109. In some implementations, the respective parameters of the set of cell elements may be adjusted to modify the respective reflection coefficients to cause the fifth wireless signals 111, which impinge upon the second RS 110 and reflect towards the first receiver 101 to undergo a phase shift (if need) and destructively interfere with the fourth wireless signals 109 (i.e., with a further portion of the wireless signals transmitted from the third transmitter 108). This may include phase shifting the fifth wireless signals 111. The respective parameters of the set of cell elements of the second RS 110 may be adjusted by the controller, as described in relation to FIG. 1A. The first wireless signals 104 transmitted by the second transmitter 103 may similarly be unaffected by the RS 106 because of the positioning and orientation of the RS 106.

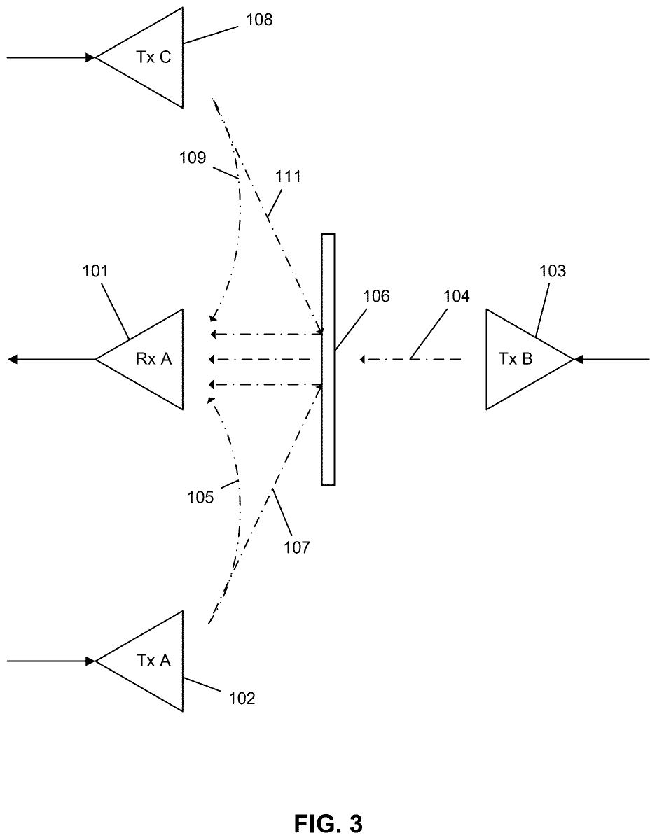

FIG. 3 shows a schematic of an example for cancellation of in-band and out-of-band interference in accordance with an embodiment of the present disclosure. Similar to the example shown in FIG. 2, the first receiver 101 belongs to the first station, and the first communication channel connects the first receiver 101 to the second transmitter 103 belonging to the second station. The first receiver 101 may similarly receive the first wireless signals 104 from the second transmitter 103. The first station may include the first transmitter 102, and the second station may include the second receiver (not shown) connected to the first transmitter 102 through the second communication channel. Similar to FIG. 2, the third transmitter 108 may be in the vicinity of the first receiver 101 and may belong to the first station or a further station that is remote to the first station and/or the second station. The third transmitter 108 may be configured to transmit wireless signals towards the further receiver (not shown) through a further communication channel operating on a frequency band different from that of the first communication channel. A respective portion of the wireless signals transmitted by the first transmitter 102 and the third transmitter 108 may leak towards the first receiver 101 (i.e., second wireless signals 105 and fourth wireless signals 109, respectively), and may be referred to collectively as ‘interference’ signals. Each of the second wireless signals 105 and the fourth wireless signals 109 may interfere with the first wireless signals 104, which may degrade the reception of the first wireless signals 104 by the first receiver 101 and cause desensitization to the first wireless signals 104. The second wireless signals 105 and the fourth wireless signals 109 may have associated thereto a respective power.

To cancel the interference from the second wireless signals 105 and the fourth wireless signals 109, a RS 106 may be placed in the vicinity of the first receiver 101. The RS 106 may be configured as described in relation to FIG. 1A. Unlike the example shown in FIG. 2, the RS 106 shown in FIG. 3 may be positioned and oriented to intercept respective further portions of the wireless signals transmitted by each of the first transmitter 102 and the third transmitter 108, which may be referred to as third wireless signals 107 and fifth wireless signals 111, respectively. Some cell elements of the plurality of cell elements (i.e., a set of cell elements) of the RS 106 may have their respective parameters adjusted to decrease, at the first receiver 101, the respective power of the second wireless signals 105. In particular, the respective parameters of the set of cell elements may be adjusted to modify the respective reflection coefficients to cause the third wireless signals 107, which impinge upon the RS 106, to reflect towards the first receiver 101 and to destructively interfere with the second wireless signals 105. This may include phase shifting the third wireless signals 107. In addition, at least some further cell elements of the plurality of cell elements (i.e., a further set of cell elements) of the RS 106 may have their respective parameters adjusted to decrease, at the first receiver 101, the respective power of the fourth wireless signals 109. In particular, the respective parameters of the set of cell elements may be adjusted to modify the respective reflection coefficients to cause the fifth wireless signals 111, which impinge upon the RS 106, to reflect towards the first receiver 101 and to destructively interfere with the fourth wireless signals 109. This may include phase shifting the fifth wireless signals 111. The respective parameters of the set of cell elements and the further set of cell elements of the RS 106 may be adjusted by the controller, as described in relation to FIG. 1A. The first wireless signals 104 transmitted by the second transmitter 103 may similarly be unaffected by the RS 106 because of its positioning and orientation. The set of cell elements and the further set of cell elements of the RS 106 may include at least one same cell element of the plurality of cell elements. In other words, some cell elements may be adjusted to cause cancellation of both the second wireless signals 105 and the fourth wireless signals 109.

In embodiments of the present disclosure, any suitable tuning mechanism may be used for effecting adjustments to the respective reflection coefficient of a cell element of a RS 106. For example, a cell element may include one of a varactor circuit, a p-i-n diode, a transistor, or another multi-state device. In some embodiments, the plurality of cell elements may include more than one of the aforementioned mechanisms. The plurality of cell elements may further be arranged into an array. In some embodiments, the array may be planar, such that the cell elements are arranged, for example, in a two-dimensional rectangular grid. In some other embodiments, the array may be non-planar, such that the cell elements are arranged, for example, cylindrically or spherically.

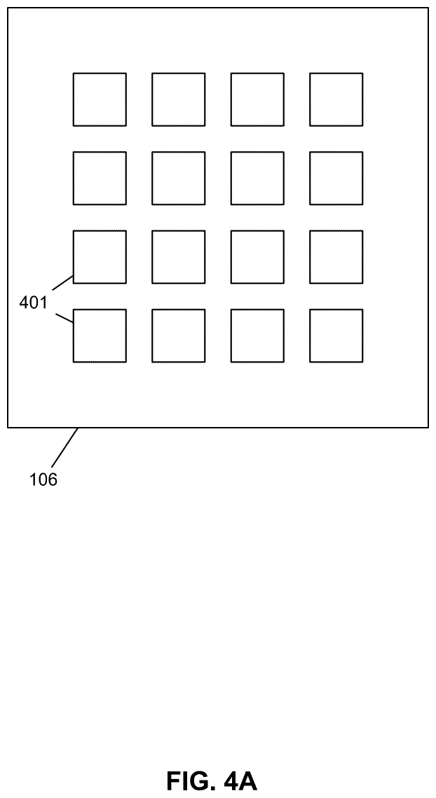

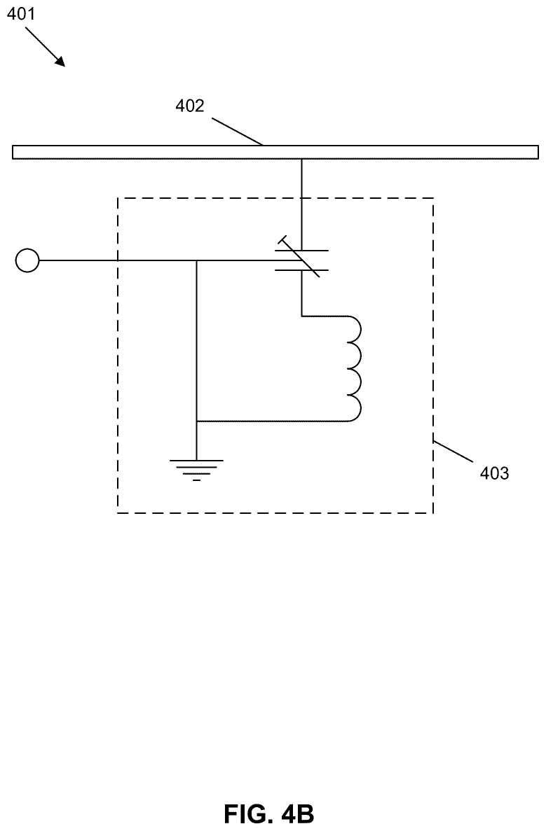

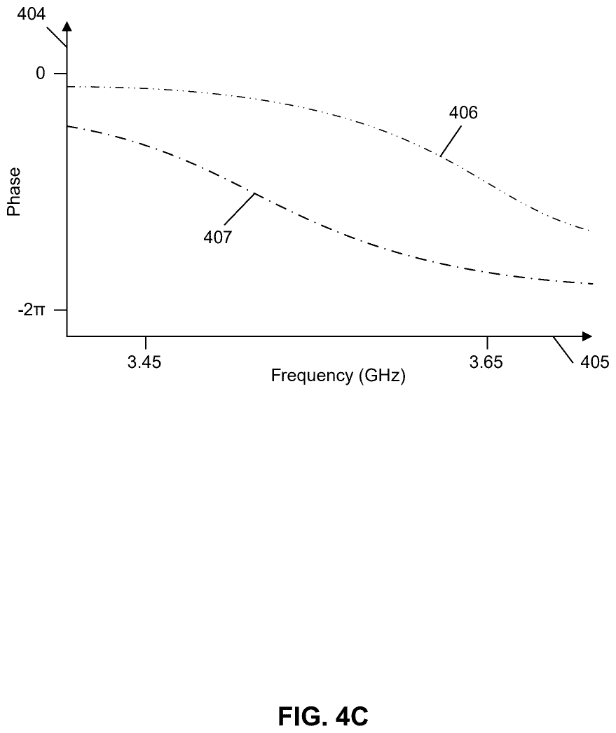

FIG. 4A shows an example of a RS 106 according to an embodiment of the present disclosure. The RS 106 comprises a plurality of cell elements 401, which, in this example, are arranged in a planar, rectangular array. In this example, each cell element 401 is operated by a respective varactor circuit.

FIG. 4B shows an example of a cell element 401 according to an embodiment of the present disclosure. The cell element 401 may, for example, be used in the RS 106 shown in FIG. 4A. The cell element 401 comprises a reflecting surface 402 and a varactor circuit 403. The reflecting surface may be configured to interact with incident wireless signals and may have associated thereto a respective reflection coefficient. The reflection coefficient of the reflecting surface 402 may be configured to be adjusted by the varactor circuit 403, which may be operated by an applied voltage. In particular, the phase component of the reflection coefficient may be adjusted by the voltage.

FIG. 4C shows a plot of an example of phase shifts 404 of a cell element 401 over a range of wireless frequencies 405 in response to a first applied voltage 406 and a second applied voltage 407, in accordance with an embodiment of the present disclosure. In this example, the first applied voltage is 1 volt and the second applied voltage is 23 volts. The range of frequencies 405 over which the cell element may operate may extend from at least 3.4 GHz to 3.7 GHz. The example shows that the phase shift can be controllably adjusted according to the applied voltage over the range of frequencies.

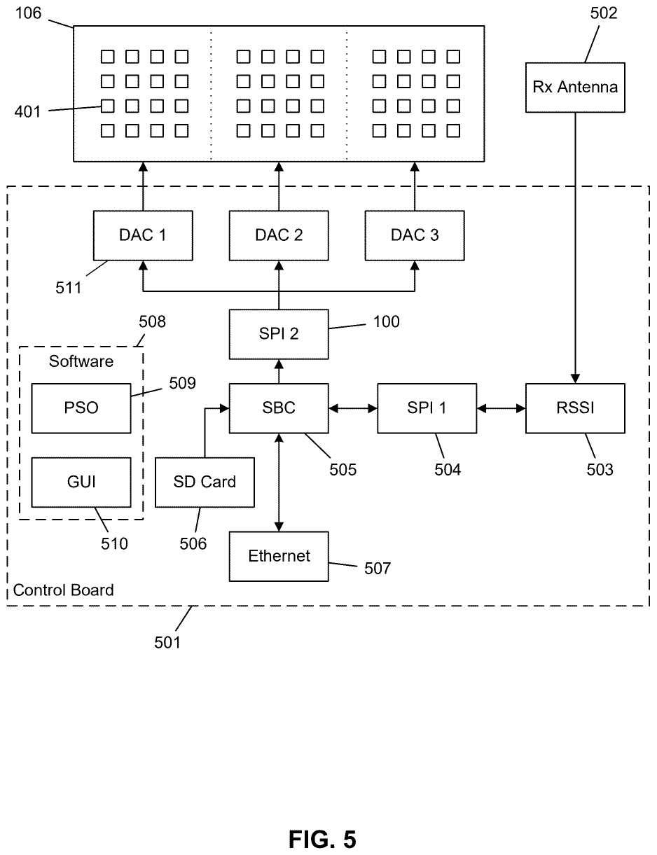

FIG. 5 shows a schematic of an example of a receiver and RS 106 at a station, in accordance with an embodiment of the present disclosure. The station comprises a RS 106, a controller 501, and an antenna 502. The RS 106 may comprise a plurality of cell elements 401 and may be configured similarly to that described in relation to FIG. 4A. Each of the antenna 502 and the RS 106 may be coupled to the controller 501 through a respective one or more electrical connections. The antenna 502 may be configured to receive wireless signals and may generate an electrical signal in response to receiving one or more wireless signals. The electrical signal may have associated thereto a performance metric having a value that depends from the respective power of each wireless signal received. The performance metric may, as shown in the example of FIG. 5, be a RSSI 503. The controller 501 may receive the electrical signal from the antenna 502 and obtain the RSSI 503 through a first serial peripheral interface (SPI 1) 504. The controller 501 may then process the RSSI 503 through a processor, such as one part of a single-board computer (SBC) 505, as shown in the example of FIG. 5. The processor may further be communicatively coupled with: memory, which may further be included in the SBC 505; storage, such as a secure digital (SD) card 506; and a network connection, such as an ethernet connection 507. The processor may be configured to implement instructions, such as software 508, stored in memory. This may include being configured to determine adjustments to the respective parameters of a set of cell elements 401 of the RS 106. It may further include being configured to determine these adjustments to optimize the value of the performance metric, i.e., the RSSI 503. Optimization may be achieved by implementing an iterative optimization algorithm, such as an artificial intelligence algorithm. In particular, optimization may be achieved by implementing a particle swarm optimizer (PSO) 509 (described in further detail below). The processor and memory may further be configured to implement a graphical user interface (GUI) 510 for communication with a user. Adjustments to the respective parameters of cell elements 401 of the RS 106 may be implemented by one or more digital-to-analog converters (DACs) 511. Each DAC 511 may be configured to adjust the respective parameters, such as a voltage, of each cell element belonging to a respective group of cell elements 401 among the plurality of cell elements 401 of the RS 106. In the example shown in FIG. 3, the plurality of cell elements 401 of the RS 106 is divided into three groups (indicated by dotted lines), each corresponding to a respective DAC 511 of three DACs 511.

In embodiments of the present disclosure, various algorithms may be used towards optimally adjusting parameters of the cell elements 401 of a RS 106. As mentioned above, a PSO 509 may be used in optimizing the parameters. For example, a PSO 509 may be used to optimize the respective voltages applied to respective varactor circuits for each cell element 401 of the RS 106. In this case, a set of N particles may be defined, with a respective position xᵢ of each particle in a search space for an optimum of the performance metric (e.g., the RSSI 503) corresponding to a respective combination of voltages for the cell elements 401 of the RS 106. The respective positions of the N particles may be varied by iterative movement of the N particles throughout the search space to locate the optimum. In a typical PSO 509, the respective position of the i^{th} particle at the k+1^{th} iteration may be updated according to a respective velocity vᵢ for that iteration, according to:

$${x}_{i} ( k + 1 ) = {x}_{i} ( k ) + {v}_{i} ( k + 1 ) \qquad ( 2 )$$

The velocity may be calculated according to the following sum:

$${v}_{i} ( k + 1 ) = ϕ ( k ) {v}_{i} ( k ) + {α}_{1} [ {γ}_{1 i} ( {p}_{i} - {x}_{i} ( k ) ) ] + {α}_{2} [ {γ}_{2 i} ( G - {x}_{i} ( k ) ) ] \qquad ( 3 )$$

The first term of the sum, φ(k)vᵢ(k), modifies the i^{th} particle's current velocity at the k^{th} iteration according to an inertia function (k). The second term, α₁[γ₁ᵢ(pᵢ−xᵢ(k))], adds velocity according to the i^{th} particle's separation from a personal best position, pᵢ, for that particle, which represents the position of that particle that has been closest to the optimum over all iterations so far, and according to an acceleration constant, α₁, and an inertia factor, γ₁ᵢ. The third term, α₂[γ₂ᵢ(G−x₁(k)], adds velocity according to the i^{th} particle's separation from a global best position, G, for all N particles, which represents the position among all N particles of that has been closest to the optimum over all iterations so far, and according to a further acceleration constant, α₂, and a further inertia factor, γ₂ᵢ. The acceleration constants and inertia factors may be set to balance exploration and exploitation in searching for the optimum. The performance metric may be evaluated according to the positions of the particles at each iteration to determine progression towards the optimum. Iteration of the PSO algorithm 509 may proceed until a pre-determined threshold, convergence, or other criteria is reached.

When optimizing an RS 106, the PSO algorithm 509 may be modified such that Equation 3 presented above takes the form:

$${v}_{i} ( k + 1 ) = {w}_{i} ( k ) [ {v}_{i} ( k ) + {α}_{1} ( k ) {γ}_{1 i} ( k ) ( {p}_{i} - {x}_{i} ( k ) ) + {α}_{2} ( k ) {γ}_{2 i} ( k ) ( G - {x}_{i} ( k ) ) ] \qquad ( 4 )$$

$${w}_{i} ( k ) = 0.6 \frac{{( k - N )}^{2}}{{N}^{2}} + 0.1 \qquad ( 5 )$$

$${α}_{1} ( k ) = - 3.9 \frac{k}{N} + 3.9 \qquad ( 6 )$$

$${α}_{2} ( k ) = 3.9 \frac{k}{N} + 0.1 \qquad ( 7 )$$

$${γ}_{1 i} ( k ) , {γ}_{2 i} ( k ) ∈ U ( 0 , 2 ) \qquad ( 8 )$$

The modifications represent one non-limiting example of a method that may encourage the PSO algorithm to allow the personal bests of the particles to have a greater influence on the trajectories of the particles in early iterations and then gradually allow the global best to more greatly impact trajectories in later iterations. The modifications may enable better coverage of high dimensionality solution spaces with fewer iterations of the algorithm and more repeatable performance of the RS. In other words, the modifications may help achieve better, more repeatable results.

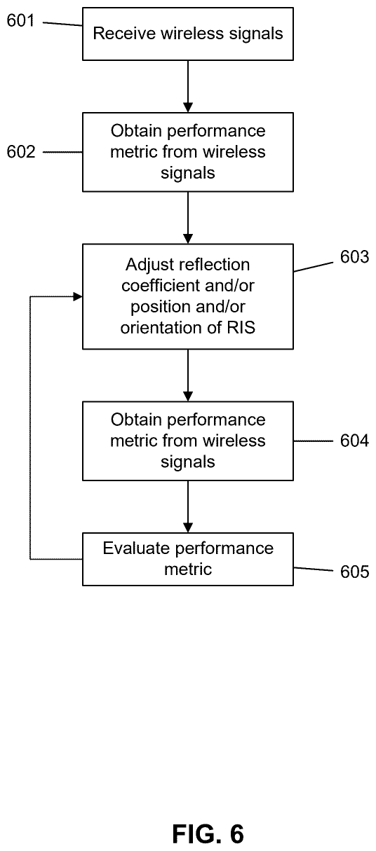

FIG. 6 shows a flowchart of a method for optimizing the performance metric of a receiver receiving wireless signals, in accordance with an embodiment of the present disclosure. The receiver may belong to a station which may further comprise a RS 106 and a controller 501, which may be configured similarly to those components described in relation to FIG. 5. At action 601, the receiver may receive, by an antenna 502, one or more wireless signals each having associated thereto a respective power. The one or more wireless signals may include a desired signal and/or interfering signals. The receiver may further generate, in response to receiving the one or more wireless signals, an electrical signal having associated thereto a value of a performance metric that depends from the respective power of each wireless signal received. At action 602, the controller 501 may obtain the value of the performance metric from the electrical signal. At action 603, the controller 501 may adjust the parameters of at least one set of cell elements 401 belonging to the RS 106 and thereby adjust the respective reflection coefficient of each cell element 401 of the set of cell elements 401. These adjustments may be made to optimize the value of the performance metric. The adjustments may further be determined according to an optimization technique such as a PSO 509 algorithm, as described previously. At action 603, the positions and/or orientation of the RS 106 may be adjusted in addition to or alternatively to the parameters of the cell elements 401. The position and/or orientation may be adjusted, for example, to achieve course adjustment and optimization of the value of the performance metric. At action 604, the controller 501 may again obtain the value of the performance metric associated with the electrical signal generated in response to reception of wireless signals. At action 605, the controller 501 may evaluate the performance metric, such as by comparing its value obtained at action 604 to that obtained at action 602. The controller may then return to performing action 603 to further optimize the value of the performance metric by refining the adjustments to the parameters of cell elements 401 and/or the position and/or orientation of the RS 106. Moreover, actions 603 to 605 may be repeated iteratively towards optimization of the value of the performance metric.

In some embodiments of the present disclosure, the method described in relation to FIG. 6 may be performed for interfering signals in the absence of a desired signal. In this case, the at least one set of cell elements of the RS 106 may be adjusted to decrease the total power of wireless signals received by the RS 106, which may, for example, be indicated by a RSSI 503 obtained from the antenna 502. When the desired signal is received, the method may be performed again to refine the optimization of the RS 106. In this case, the refinements may be done to optimize a different performance metric, such as a SIR obtained from the antenna 502.

In some embodiments of the present disclosure, the at least one set of cell elements 401 described in relation to FIG. 6 may change between iterations performed towards optimizing the value of the performance metric. In other words, one or more cell elements 401 of the plurality of cell elements 401 of the RS 106 may be added and/or removed from the at least one set of cell elements 401.

Embodiments of the present disclosure may be implemented towards full-duplex communication systems to cancel in-band and/or out-of-band interference. In these implementations, a respective RS 106 may be deployed at each station of the communication system to cancel at least interfering wireless signals received by a respective receiver from a respective transmitter. A respective controller 501 at each station may be configured to adjust and optimize the respective RS 106. Embodiments may further be implemented towards flexible-time-division duplexing (TDD) systems to mitigate increased inter-system interference, in-band or out-of-band from an adjacent channel, which can, for example, be due to asynchronous uplink and downlink channels. Further embodiments may be implemented towards sub-band full-duplex (SBFD) systems or similar systems to cancel in-band and/or out-of-band interference, as another example.

Embodiments of the present disclosure may be implemented using electronics hardware, software, or a combination thereof. In some embodiments, the invention may be implemented by one or multiple computer processors executing program instructions stored in memory. In some embodiments, the invention may be implemented partially or fully in hardware, for example using one or more field programmable gate arrays (FPGAs) or application specific integrated circuits (ASICs) to rapidly perform processing operations.

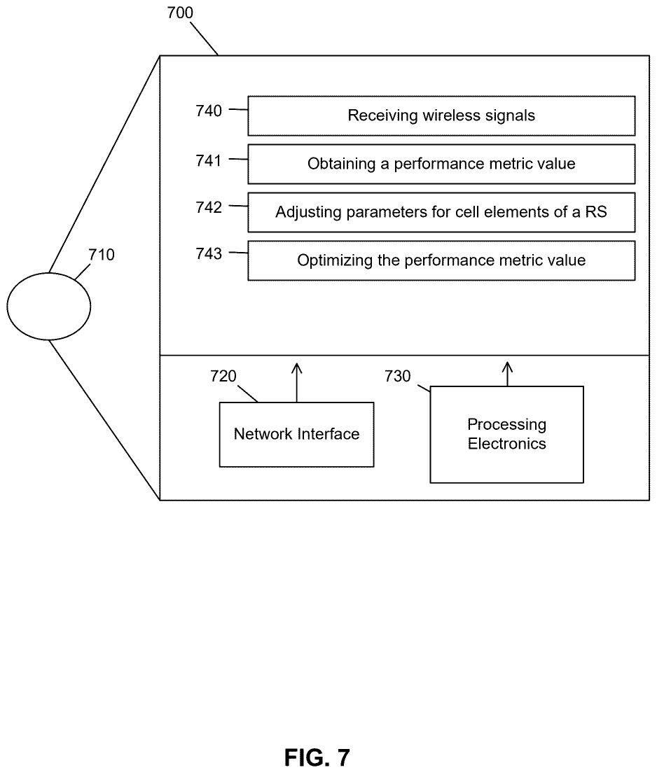

FIG. 7 shows an apparatus 700 for over-the-air cancellation, according to embodiments of the present disclosure. The apparatus 700 may, for example, be configured to implement the receiver and controller 501 described in relation to FIG. 5. The apparatus 700 may be located at a node 710, such as a station, of a network. The apparatus may include a network interface 720 and processing electronics 730. The processing electronics 730 may include a computer processor executing program instructions stored in memory, or other electronics components such as digital circuitry, including for example FPGAs, ASICs, and SBCs 505. The processing electronics 730 may, for example, be configured to implement the controller 501 described in relation to FIG. 5. The network interface 720 may include an optical communication interface or radio communication interface, such as a transmitter and receiver antenna, or an ethernet connection 507. The apparatus 700 may include several functional components, each of which may be partially or fully implemented using the underlying network interface 720 and processing electronics 730. Examples of functional components may include modules for receiving 704 wireless signals, obtaining 741 a performance metric value, adjusting 742 parameters for cell elements of a RS, and optimizing 743 the performance metric value.

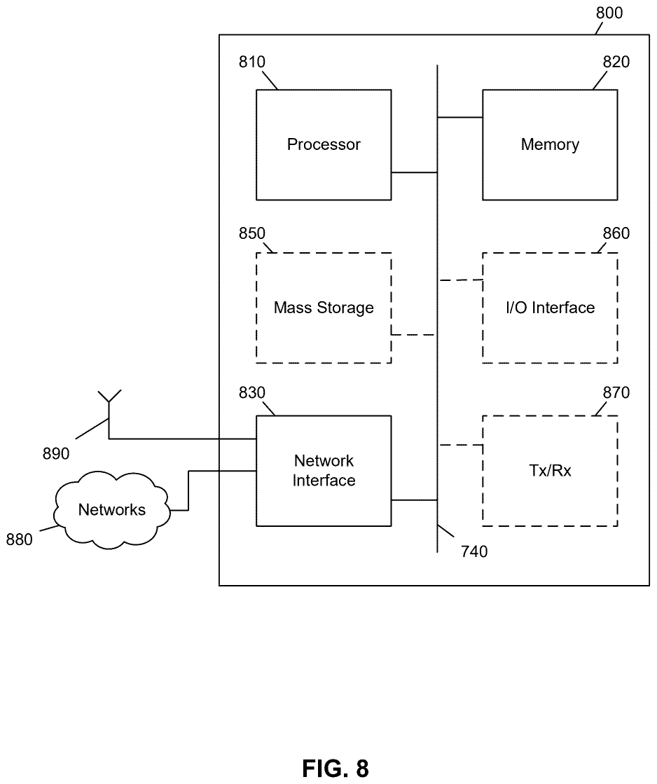

FIG. 8 shows a schematic diagram of an electronic device 800 that may perform any or all of the operations of the above methods and features explicitly or implicitly described herein, according to different embodiments of the present disclosure. For example, a computer equipped with network function may be configured as electronic device 800. The electronic device 800 may be used to implement the apparatus 700 of FIG. 7, for example. The electronic device 800 may further be used as part of a station, a receiver, or a controller 501, for example.

As shown, the electronic device 800 may include a processor 810, such as a central processing unit (CPU) or specialized processors such as a graphics processing unit (GPU) or other such processor unit. The electronic device 800 may further include memory 820, a network interface 830, and a bi-directional bus 840 to communicatively couple the components of electronic device 800. Electronic device 800 may also optionally include non-transitory mass storage 850, an I/O interface 860, and a transceiver 870. According to certain embodiments, any or all of the depicted elements may be utilized, or only a subset of the elements. Further, the electronic device 800 may contain multiple instances of certain elements, such as multiple processors, memories, or transceivers. Also, elements of the hardware device may be directly coupled to other elements without the bi-directional bus 840. Additionally or alternatively to a processor and memory, other electronics, such as integrated circuits or a SBC 505, may be employed for performing the required logical operations.

The memory 820 may include any type of tangible, non-transitory memory such as static random access memory (SRAM), dynamic random access memory (DRAM), synchronous DRAM (SDRAM), read-only memory (ROM), any combination of such, or the like. The mass storage element 850 may include any type of tangible, non-transitory storage device, such as a solid state drive, hard disk drive, a magnetic disk drive, an optical disk drive, USB drive, SD card 506, or any computer program product configured to store data and machine executable program code. According to certain embodiments, the memory 820 or mass storage 850 may have recorded thereon statements and instructions executable by the processor 810 for performing any of the aforementioned method operations described above.

Network interface 830 may include at least one of a wired network interface and a wireless network interface. The network interface 830 may include a wired network interface to connect to a communication network 880 and may also include a radio access network interface 890 for connecting to the communication network 880 or other network elements over a radio link. The network interface 830 may, for example, include an ethernet connection 507. The network interface 830 may enable the electronic device 800 to communicate with remote entities such as those connected to the communication network 880.

Transceiver 870 may enable the electronic device 800 to receive and/or transmit wireless signals, such as radio signals. The transceiver 870 may include a transmitter antenna and/or a receiver antenna 502.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, personal digital assistant (PDA), or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), universal serial bus (USB) flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise. The phrase “at least one” means one or more, and “a plurality of” means two or more. In addition, “and/or” describes an association relationship of associated objects, and indicates that there may be three relationships. For example, A and/or B may indicate cases including “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent “a”, “b”, “c”, “a and b”, “a and c”, “b and c”, or “a, b and c”, where a, b, and c may be a single or multiple form.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A communication system comprising:
a receiver including an antenna configured to receive one or more wireless signals each having associated thereto a respective power, the receiver configured to produce, in response to receiving the one or more wireless signals, an electrical signal having associated thereto a performance metric having a performance metric value that depends from the respective power of each of the one or more wireless signals;
a reconfigurable surface (RS) including a plurality of cell elements, each cell element of the plurality of cell elements having at least one respective parameter configured to be adjusted to modify a respective reflection coefficient of the respective cell element;
and
a controller coupled to the receiver and to the plurality of cell elements of the RS, the controller configured to obtain the performance metric value and to optimize the performance metric value by adjusting the at least one respective parameter of each cell element of a set of cell elements among the plurality of cell elements of the RS to decrease, at the antenna of the receiver, the respective power of at least one wireless signal among the one or more wireless signals.

2. The communication system of claim 1 wherein the controller is configured to optimize the performance metric value by adjusting the at least one respective parameter of each cell element of the set of cell elements of the RS to reflect a first portion of the at least one wireless signal towards the antenna of the receiver to cause the first portion of the at least one wireless signal to destructively interfere with a second portion of the at least one wireless signal at the antenna of the receiver.

3. The communication system of claim 2 wherein the controller is configured to adjust the at least one respective parameter of each cell element of the set of cell elements of the RS to phase shift the first portion of the at least one wireless signal.

4. The communication system of claim 1 wherein:
the one or more wireless signals includes a first wireless signal transmitted from a first transmitter antenna and a second wireless signal transmitted from a second transmitter antenna;
and
decreasing, at the antenna of the receiver, the respective power of the at least one wireless signal includes:
decreasing, at the antenna of the receiver, the respective power of the first wireless signal or the second wireless signal.

5. The communication system of claim 1 wherein:
the one or more wireless signals includes a first wireless signal transmitted from a first transmitter antenna and a second wireless signal transmitted from a second transmitter antenna;
the first transmitter antenna is remote to the communication system;
the communication system further comprises the second transmitter antenna;
and
decreasing, at the antenna of the receiver, the respective power of the at least one wireless signal among the one or more wireless signals includes:
decreasing, at the antenna of the receiver, only the respective power of the second wireless signal among the one or more wireless signals.

6. The communication system of claim 5 wherein:
the RS is positioned between the second transmitter antenna and the antenna of the receiver;
and
the RS is oriented to cause a portion of the second wireless signal transmitted from the second transmitter antenna to be reflected towards the antenna of the receiver.

7. The communication system of claim 1 wherein the controller is further configured to optimize the performance metric value by adjusting the at least one respective parameter of each cell element of a further set of cell elements among of the plurality of cell elements of the RS to decrease, at the antenna of the receiver, the respective power of a further at least one wireless signal among the one or more wireless signals.

8. The communication system of claim 7 wherein at least one cell element of the set of cell elements of the RS and at least one cell element of the further set of cell elements of the RS are a respective same cell element among the plurality of cell elements of the RS.

9. The communication system of claim 1 wherein the RS has, relative to the antenna of the receiver, a position and an orientation configured to further optimize the performance metric value by further decreasing, at the antenna of the receiver, the respective power of the at least one wireless signal among the one or more wireless signals.

10. The communication system of claim 1 wherein the controller is configured to optimize the performance metric value by implementing an iterative optimization algorithm.

11. The communication system of claim 10 wherein the iterative optimization algorithm is an artificial intelligence algorithm.

12. The communication system of claim 11 wherein the artificial intelligence algorithm is a particle swarm optimization algorithm.

13. The communication system of claim 1 wherein:
the at least one respective parameter of each cell element of the plurality of cell elements includes a respective voltage;
the controller includes one or more digital-to-analog converters (DACs) configured to adjust, for each cell element of a respective group of cell elements among the plurality of cell elements of the RS, the respective voltage;
and
the controller is configured to optimize the performance metric value by controlling the DACs to adjust, for each cell element of the respective group of cell elements among the plurality of cell elements of the RS, the respective voltage.

14. The communication system of claim 13 wherein:
the respective reflection coefficient of each cell element includes a respective phase component;
and
the at least one respective parameter of each cell element being configured to be adjusted to modify the respective reflection coefficient includes:
the respective voltage of each cell element being configured to be adjusted to modify the respective phase component.

15. The communication system of claim 1 wherein:
the at least one respective parameter of each cell element of the plurality of cell elements includes a respective current;
and
the controller is configured to optimize the performance metric value by adjusting the respective current of each cell element of the set of cell elements of the RS.

16. The communication system of claim 1 wherein:
the performance metric value depends from a sum of the respective power of each wireless signal of the one or more wireless signals;
and
the controller is configured to minimize the sum of the respective power of each wireless signal of the one or more wireless signals by adjusting the at least one respective parameter of the each cell element of the set of cell elements among the plurality of cell elements of the RS to decrease, at the antenna of the receiver, the respective power of the at least one wireless signal among the one or more wireless signals.

17. A full-duplex communication system comprising:
a first station including:
a first receiver antenna,
a first transmitter antenna,
a reconfigurable surface (RS) including a plurality of cell elements, each cell element of the plurality of cell elements having at least one respective parameter configured to be adjusted to modify a respective reflection coefficient of the respective cell element,
and
a controller coupled to the first receiver antenna and to the plurality of cell elements of the RS;
and
a second station including:
a second receiver antenna,
and
a second transmitter antenna;
the first transmitter antenna configured to transmit wireless signals towards the second receiver antenna;
the second transmitter antenna configured to transmit wireless signals towards the first receiver antenna;
each wireless signal having associated thereto a respective power;
and
the controller configured to adjust the at least one respective parameter of each cell element of a set of cell elements among the plurality of cell elements of the RS to decrease, at the first receiver antenna, the respective power of wireless signals transmitted from the first transmitter antenna.

18. The full-duplex communication system of claim 17 wherein the second station further includes:
a further RS including a further plurality of cell elements, each cell element of the further plurality of cell elements of the further RS having at least one respective parameter configured to be adjusted to modify a respective reflection coefficient of the respective cell element;
and
a further controller coupled to each of the second receiver antenna and the further RS, the further controller configured to adjust the at least one respective parameter of each cell element of a further set of cell elements among the plurality of cell elements of the further RS to decrease, at the second receiver antenna, the respective power of wireless signals transmitted from the second transmitter antenna.

19. A method comprising, at a receiver station:
producing, in response to receiving one or more wireless signals by an antenna, an electrical signal, each wireless signal having associated thereto a respective power, the electrical signal having associated thereto a performance metric having a performance metric value that depends from the respective power of each of the one or more wireless signals;
obtaining, by a controller coupled to the antenna, the electrical signal, the controller further coupled to a reconfigurable surface (RS) including a plurality of cell elements, each cell element of the plurality of cell elements having at least one respective parameter configured to be adjusted to modify a respective reflection coefficient of the respective cell element;
and
adjusting, by the controller, at least one respective parameter of each cell element of a set of cell elements among the plurality of cell elements of the RS to cause the RS to decrease, at the antenna, the respective power of at least one wireless signal among the one or more wireless signals to optimize the performance metric value.

20. The method of claim 19 wherein adjusting, by the controller, the at least one respective parameter of each cell element of the set of cell elements among the plurality of cell elements of the RS to cause the RS to decrease, at the antenna, the respective power of the at least one wireless signal among the one or more wireless signals to optimize the performance metric value includes:
implementing, by the controller, an artificial intelligence algorithm.
